(19) United States
(12) Patent Application Publication
(10) Pub. No.: US 2026/0313636 A1
(43) Pub. Date: Oct. 8, 2026

(54) TWO-STEP SCHEDULING REQUEST

(71) Applicant: QUALCOMM Incorporated, San Diego, CA (US)

(72) Inventors: Jianghong LUO, Skillman, NJ (US); Navid ABEDINI, Basking Ridge, NJ (US); Tao LUO, San Diego, CA (US); Junyi LI, Greentown, PA (US); Xiaoxia ZHANG, San Diego, CA (US)

(21) Appl. No.: 19/173,707

(22) Filed: Apr. 8, 2025

(51) Int. Cl. H04W 72/1263; H04B 7/0413; H04L 5/00; H04W 52/02

(52) U.S. Cl. CPC H04W 72/1263; H04B 7/0413; H04L 5/0044; H04W 52/0235

(57) ABSTRACT

Certain aspects of the present disclosure provide techniques for wireless communications. An example method includes transmitting a first scheduling request (SR) message, wherein the first SR message indicates use of a set of uplink transmission resources for a second SR message; transmitting the second SR message on the set of uplink transmission resources after transmitting the first SR message; and receiving: a first downlink message indicating that the second SR message has been received, or a second downlink message indicating that the second SR message has not been received.

### INTRODUCTION

### Field of the Disclosure

Aspects of the present disclosure relate to wireless communications, and more particularly, to techniques for two-step scheduling requests.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method for wireless communications by a user equipment (UE). The method includes transmitting a first scheduling request (SR) message, wherein the first SR message indicates use of a set of uplink transmission resources for a second SR message; transmitting the second SR message on the set of uplink transmission resources after transmitting the first SR message; and receiving: a first downlink message indicating that the second SR message has been received, or a second downlink message indicating that the second SR message has not been received.

Certain aspects provide a method for wireless communications by a network entity. The method includes receiving a first SR message, wherein the first SR message indicates use of a set of uplink transmission resources; receiving a second SR message on the set of uplink transmission resources; and transmitting: a first downlink message indicating that the second SR message has been received, or a second downlink message indicating that the second SR message has not been received.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5A depicts an example four-step random access procedure.

FIG. 5B depicts an example two-step random access procedure.

FIG. 6 depicts an example user equipment configured with a low power wake-up receiver and a main receiver.

FIG. 7 depicts an example procedure using a wake-up signal mechanism.

FIG. 8 depicts a process flow for communications in a network.

FIG. 9 depicts a method for wireless communications.

FIG. 10 depicts another method for wireless communications.

FIG. 11 depicts aspects of an example communications device.

FIG. 12 depicts aspects of an example communications device.

### DETAILED DESCRIPTION

Aspects of the present disclosure provide apparatuses, methods, processing systems, and computer-readable mediums for two-step scheduling requests (SRs).

Wireless communication networks are expected to deliver high quality-of-service (QoS) to a variety of use cases, such as ultra-reliable Low-Latency Communication (uRLLC), Massive Machine-Type Communication (mMTC), and Enhanced Mobile Broadband (eMBB). As a result, scheduling of data transmissions is a very important part of mobile networks, with the performance of a network's data throughput depending on scheduling algorithms.

A scheduling algorithm dynamically allocates resources, including time, frequency, and power, to serve user equipment (UEs) connected to a network entity (such as a gNB or base station) on a 5G network. The data scheduler exists in the network entity and coordinates the data transmissions on both uplink and downlink legs for all UEs within its cell range. An efficient scheduling algorithm may use three sets of information. First is the QoS expectations, e.g., the priorities, maximum error rates or maximum delays of the individual UE. Next, the data buffer status for each UE, e.g., the amount of data in a buffer and the length of time that the data has been in the buffer. For example, there may be delay-sensitive data which will have higher priority than some bulk download data. Third are the channel conditions. For instance, a UE may have lots of data in its buffer, but be subject to weak channel conditions so no matter the amount of radio resources allocated for the UE, not much data will get through.

In some scheduling algorithms, an individual UE sends a scheduling request (SR) in the physical uplink control channel (PUCCH) to a network entity when the UE expects to transmit data to the network. The network entity can dynamically allocate uplink transmission resources and sends a grant to the UE using downlink control information (DCI) in the physical downlink control channel (PDCCH). The grant allows the UE to transmit data according to the allocated resources in the physical uplink shared channel (PUSCH).

Individual UEs may send frequent SRs, and corresponding network entities may send corresponding grants, in order to control latency. However, in an environment with multiple UEs, a technical problem arises because of the overhead when using this scheme. For example, a network entity may configure one SR configuration per UE, and this SR configuration may be shared for all SR triggering usages of the UE. SR configurations for different UEs may be configured to be orthogonal to one another in frequency, time, or cyclic shift domains to facilitate multiplexing. To save energy at the network entity, it is desirable to align SR resources across UEs in time as much as possible so that the network entity does not have to remain awake to receive SRs at different times. The single SR configuration of a single UE can be a single-bit SR (e.g., a PUCCH short format 0), a multi-bit SR, or a combination thereof. Technical challenges arise for each of these SR configurations. For example, for a single-bit SR, the network entity cannot differentiate a reason or urgency of the SR, meaning that the network entity must request more information from the UE (e.g., by sending a grant for PUSCH that will carry a buffer status report, a delay status report, or medium access control signaling. For a multi-bit SR, the network entity can differentiate the reason or urgency of SR and can make a scheduling decision accordingly, but this involves more PUCCH resource overhead than a single-bit SR, thereby reducing multiplexing capability among multiple UEs. Thus, without additional signaling, the network entity cannot determine a reason or urgency of the SR, so high-priority traffic may be dropped in favor of low-priority traffic, or the network entity may sub-optimally allocate resources.

Aspects described herein relate to techniques for transmitting SRs in two steps. A first SR message (such as a first component of an SR or a first part of an SR) may indicate a set of uplink transmission resources for a second SR message. A network entity may monitor the set of uplink transmission resources once the first SR message is received and may receive the second SR message on the set of uplink transmission resources. The first SR message may comprise information such as an SR message flag, which may be similar to the single-bit message indicating that a UE has data to send. The first SR message may additionally, or alternatively, include a triggering cause of an SR, identifiers of either or both of a logical channel triggering the SR or a specific triggering UE or UE group, an indication of a time offset between the first and second SR messages, a parameter of the set of uplink transmission resources, or the like. In some aspects, some or all of this information may be transmitted in the second SR message, which may also comprise a buffer status report or beam report. Thus, various options are provided herein for information that can be provided in the first SR message and information that can be provided in the second SR message

In some aspects, the UE may transmit the first SR message on the PUCCH. In some aspects, the first SR message may comprise a low-power wakeup signal (LP-WUS), which may save power at a network entity that supports a low-power wakeup receiver (LP-WUR) mode. In some aspects, the physical random access channel (PRACH) may also be used to transmit the first SR message and/or the second SR message. For example, the first SR message may comprise a preamble and the second SR message may comprise a payload in the random access procedure.

Certain techniques for transmitting an SR in two steps may have the technical benefit of more efficiently initiating and maintaining a scheduling algorithm. A network entity may not constantly monitor a channel for SRs, thus saving energy and resources in the network. Some aspects may also have the technical benefit of providing a common set of uplink transmission resources that may be shared among multiple UEs attempting to establish communications with a common network entity. Such aspects would avoid the need to separately grant uplink transmission resources to the UEs individually and ease the multiplexing of SRs from the several UEs.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

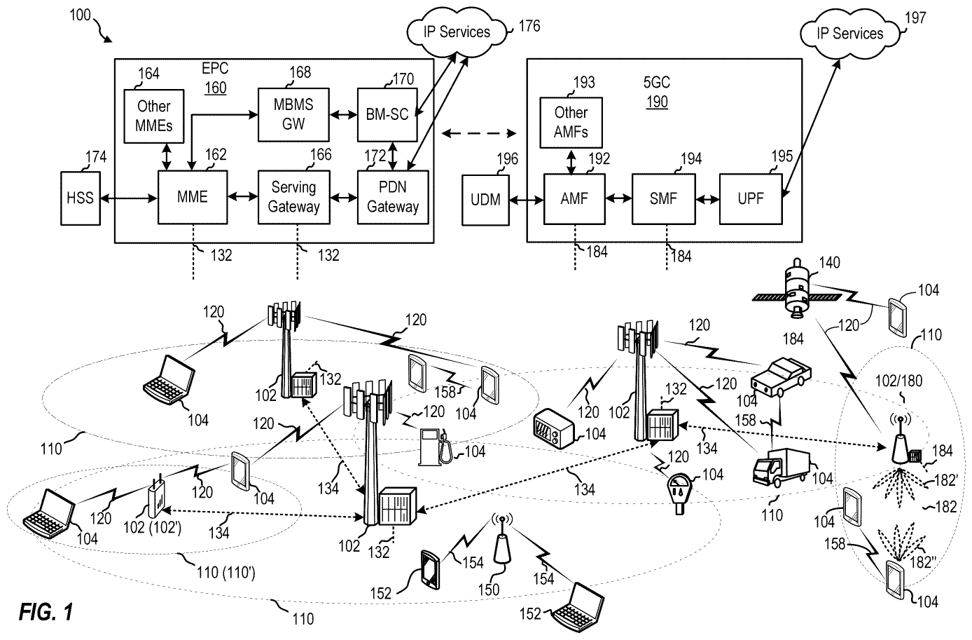

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

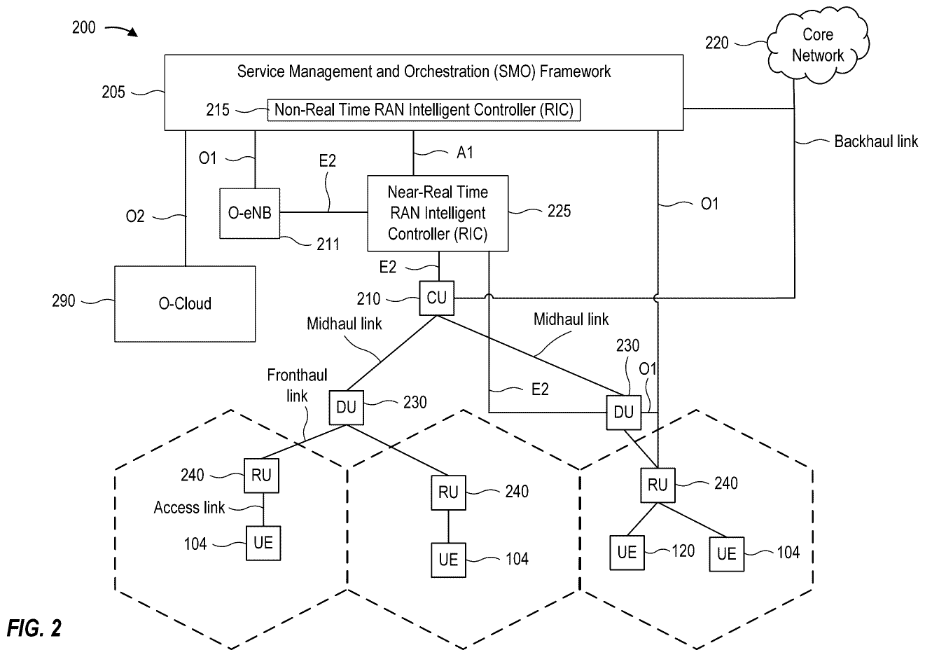

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz 71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182″. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

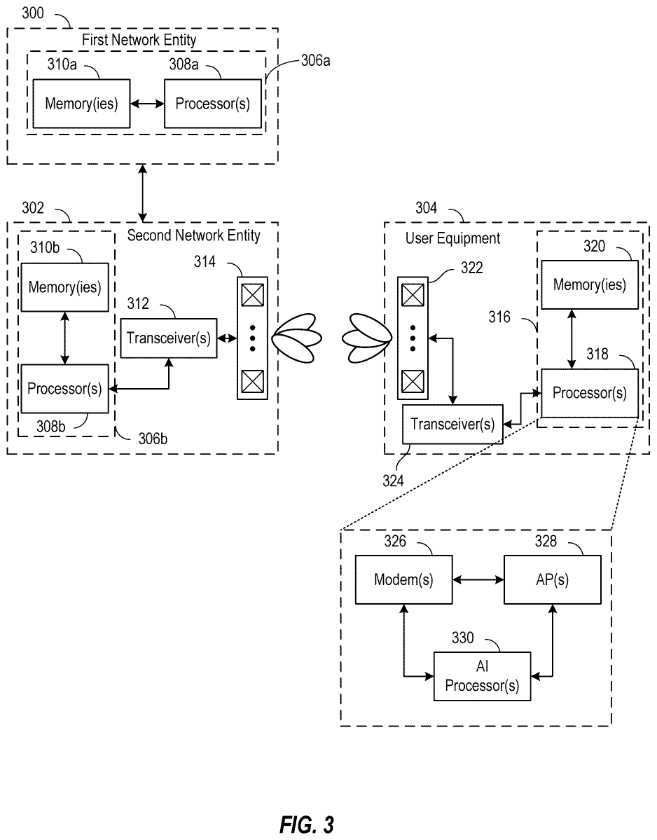

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

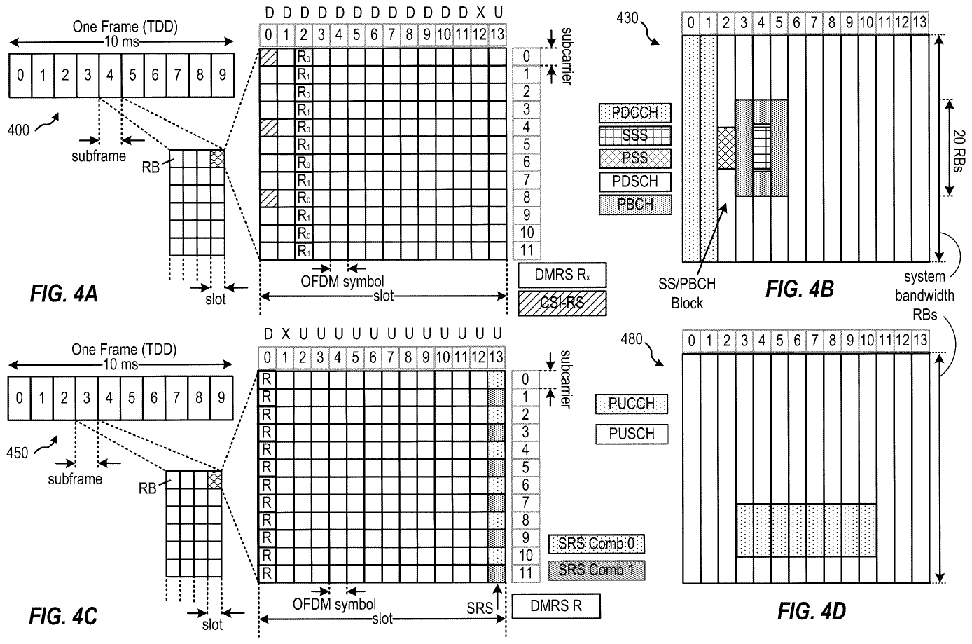

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology μ, there are 2^{μ}slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Random Access Procedures

Aspects of the present disclosure provide various schemes associated with a specified channel for random access, such as a random access channel (RACH), and corresponding random access procedure(s). The random access procedure may be performed for any of various events including, for example, initial access from an idle state (e.g., RRC idle), RRC connection re-establishment, handover, downlink (DL) and/or uplink (UL) data arrival (e.g., when the UE is in an idle state), or device positioning.

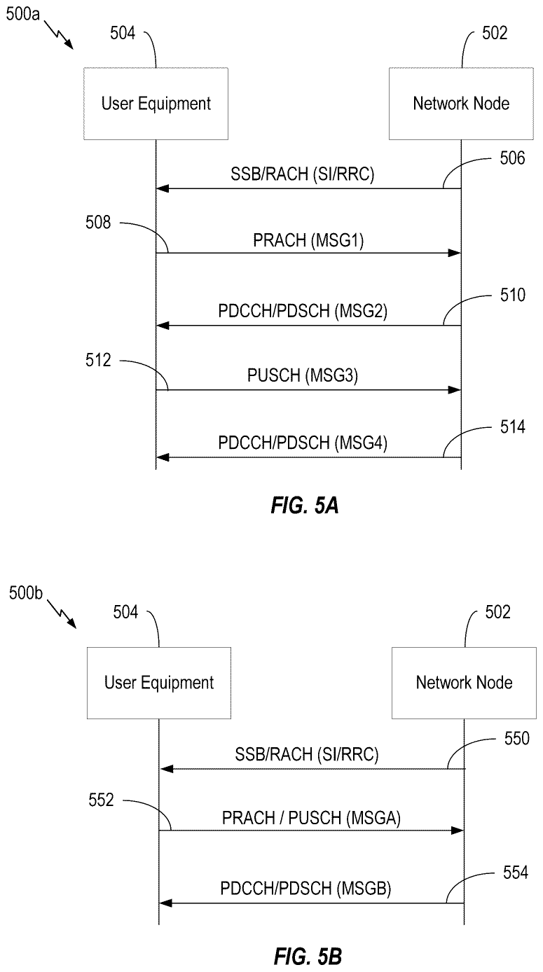

FIG. 5A depicts a process flow diagram of an example four-step RACH procedure 500a performed between a UE 504 and a network entity 502. In some aspects, the UE 504 is the UE 104 depicted and described with respect to FIGS. 1 and 3, and the network entity 502 is the base station 102 or network entity 300/302 depicted and described with respect to FIGS. 1 and 3 or a disaggregated base station depicted and described with respect to FIG. 2.

The RACH procedure 500a may optionally begin at 506, where the network entity 502 broadcasts and the UE 504 receives a random access configuration, for example, in system information (SI) within a synchronization signal block (SSB), or within an RRC message. The random access configuration may indicate or include one or more parameters for random access communications, such as defining the RACH, the total number of random access preambles (e.g., preamble sequences) available for random access, power ramping parameters, response window size (duration), etc. In some aspects, the UE 504 may obtain a plurality of random access configurations.

At 508, the UE 504 sends a first message (MSG1) to the network entity 502 on a physical random access channel (PRACH). In some cases, a PRACH may be referred to as a RACH. In some aspects, MSG1 may indicate or include a RACH preamble. The RACH preamble may be or include a preamble sequence (e.g., a Zaddoff Chu sequence). For contention-based random access, the preamble sequence may be randomly selected among a set of preamble sequences (e.g., up to 64 sequences, in some cases). The preamble sequence may be used to identify the UE 504 for scheduling communications (e.g., MSG2 and MSG3) with the network entity. In some aspects, terms such as “RACH preamble,” “random access preamble,” “preamble,” “preamble sequence,” “sequence,” and the like may be used interchangeably.

At 510, the network entity 502 may respond with a random access response (RAR) message (MSG2). For example, the network entity 502 may send a PDCCH communication including downlink control information (DCI) that schedules the RAR on the PDSCH. The RAR may include, for example, certain parameters used for an uplink transmission such as a random access (RA) preamble identifier (RAPID), a timing advance, an uplink (UL) grant (e.g., indicating one or more time-frequency resources for an uplink transmission), cell radio network temporary identifier (C-RNTI), and/or a backoff parameter value. The RAPID may correspond to the preamble sequence and indicate that the RAR is for the UE 504 that transmitted MSG1 at 506. The backoff parameter value may be used to determine a RACH occasion (RO) for sending a subsequent RACH transmission (e.g., a preamble transmission). A RACH occasion may correspond to one or more time-frequency resources available for transmitting a preamble in a RACH.

At 512, in response to MSG2, the UE 504 transmits a third message (MSG3) to the network entity 502 on the PUSCH. In some aspects, MSG3 may include an RRC connection request, a tracking area update (e.g., for UE mobility), and/or a scheduling request (for an UL transmission). As an example, MSG3 is communicated in the time-frequency resource(s) indicated in the UL grant of the RAR.

At 514, the network entity 502 may send a contention resolution message (MSG4) in response to MSG3. The network entity 502 may send a downlink scheduling command (e.g., DCI), which is addressed to a specific UE identity associated with the UE 504 as discussed below, via the PDCCH. The network entity 502 may send a UE contention resolution identity (e.g., a medium access control element) via the PDSCH according to the downlink scheduling command. In certain cases, multiple UEs may send the same preamble in the same RO. As the network entity 502 may not be able to identify which UE sent which preamble, the network entity 502 may reply with a single RAR associated with the preamble. The MSG3 may include or indicate a specific UE identity associated with the UE 504, such as a radio network temporary identifier (RNTI) or a temporary mobile subscriber identity (TMSI). The network entity 502 may decode MSG3 and determine the UE identity associated with at least one of the UEs (e.g., UE 504). MSG4 may be addressed to the UE identity (e.g., the RNTI or an RNTI based on the TMSI) associated with the MSG3 that the network entity was able to successfully decode. For example, the MSG4 may be scrambled by the RNTI associated with the MSG3. If the UE 504 obtains the same identity sent in MSG3, the UE 504 concludes that the random access procedure succeeded. In some cases, if the UE 504 is unable to obtain or decode MSG3 and/or MSG4, the UE 504 may repeat the RACH procedure, such as the four-step RACH procedure 500a.

In some cases, to reduce the latency associated with random access, a two-step RACH procedure may be used. The two-step RACH procedure may effectively consolidate the four messages of the four-step RACH procedure into two messages.

FIG. 5B depicts a process flow diagram of an example two-step RACH procedure 500b performed between the UE 504 and the network entity 502.

The procedure 500b may optionally begin at 550, where the network entity 502 broadcasts and the UE 504 receives a random access configuration, for example in system information within a synchronization signal block, or within an RRC message.

At 552, the UE 504 sends a first message (MSGA) to the network entity 502, which may effectively combine MSG1 and MSG3 described above with respect to FIG. 5A. In some aspects, MSGA includes a RACH preamble for random access and a payload. For example, the payload may include a UE-ID and other signaling information, such as a buffer status report or scheduling request. The RACH preamble of MSGA may be transmitted over the PRACH, and the payload of MSGA may be transmitted over the PUSCH, for example.

At 554, the network entity 502 may send a random access response message (MSGB), which may effectively combine MSG2 and MSG4 described above, via the PDCCH and PDSCH. For example, MSGB may include a RAPID, a timing advance, a backoff parameter value, a contention resolution message, an uplink and/or downlink grant, and transmit power control commands.

Some aspects described herein relate to providing a first SR message via a RACH preamble and a second SR message via a payload, which may be implemented as part of a two-step RACH procedure or a four-step RACH procedure, or may be implemented separately from a RACH procedure.

### Aspects Related to Low-power Wake-up Receiver Systems

Aspects of the present disclosure provide various schemes for the use of a low-power wake-up receiver (LP-WUR) (also referred to as a “low-power wake-up radio”) to monitor for certain signals (e.g., low-power wake-up signals (LP-WUSs), also simply referred to as “WUSs”) in lieu of a higher power main receiver. The LP-WUR beneficially allows a communication device (e.g., a UE or a network entity) to remain in a very low-power (or no-power) state until a period of time in which a communication intended for the device is transmitted to the device.

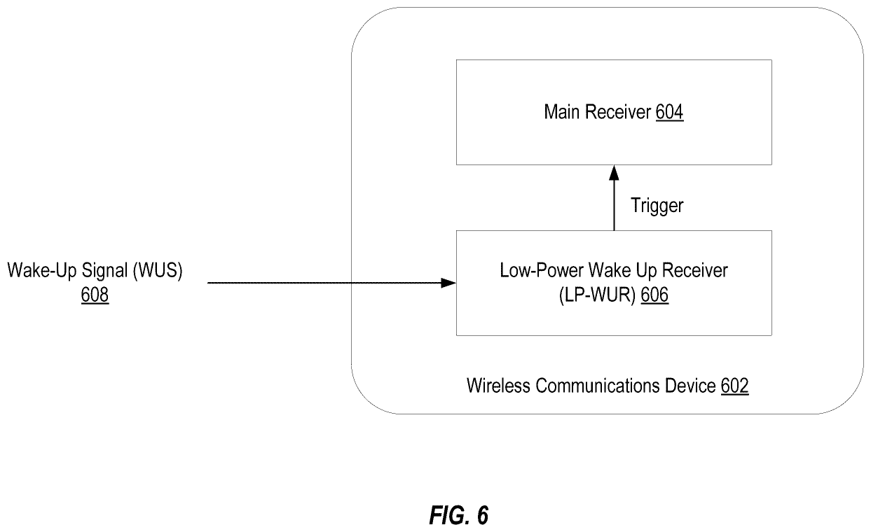

FIG. 6 depicts an example wireless communications device 602 (e.g., such as UE 104 described above with respect to FIGS. 1 and 3, a BS 102, or a network entity 300/302) configured with an LP-WUR 606 and a main receiver 604 (also referred to as a “main radio”). Main receiver 604 is a receiver configured to receive data from another wireless communications device (e.g., such as a UE or a network entity) when main receiver 604 is powered on. However, main receiver 604 generally remains powered down in the absence of scheduled downlink data to help conserve power at wireless communications device 602. It should be noted that main receiver 604 and LP-WUR 606 can be implemented as different modes of operations, and may use one or more shared components (e.g., where a shared component can operate in the same fashion as a main receiver and an LP-WUR, or in different fashions for the main receiver and the LP-WUR).

LP-WUR 606 enables main receiver 604 to remain in a powered down state, and thus conserve energy. In particular, LP-WUR 606 is a relatively simpler receiver (e.g., does not include a transmitter) that remains awake continuously (or at high-frequency intervals) to monitor for an LP-WUS 608. LP-WUS 608 is used to trigger LP-WUR 506 to wake up main receiver 604. In some aspects, LP-WUS 608 may use a relatively simple signal design, such as on-off keying. In some aspects, LP-WUS 608 may comprise a first SR message, as described elsewhere herein.

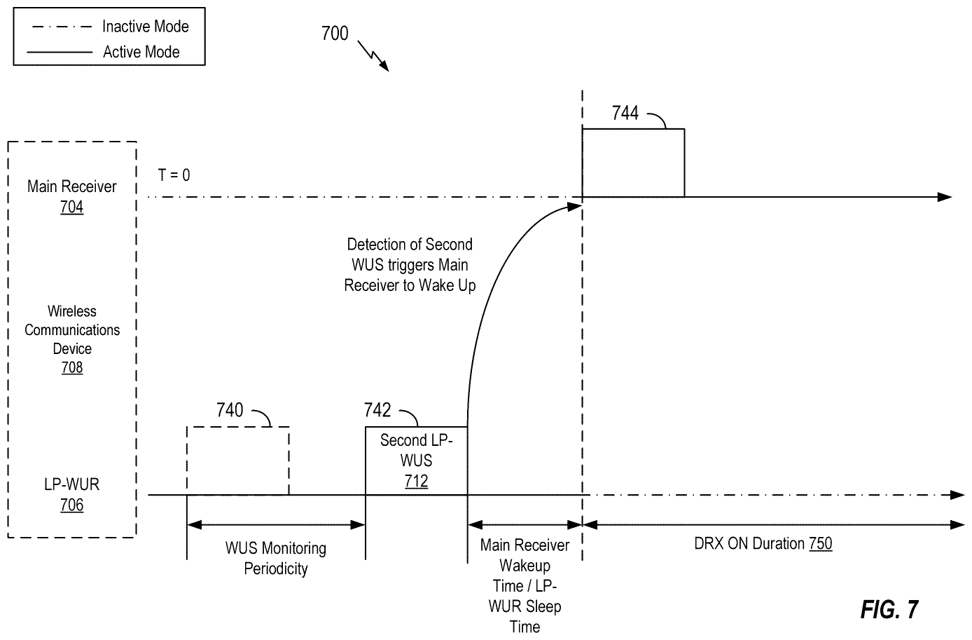

FIG. 7 depicts an example procedure 700 using an LP-WUS mechanism to wake-up a main receiver for receiving downlink data.

As depicted, a wireless communications device 708 is configured with a main receiver 704 and an LP-WUR 706 (e.g., similar to wireless communications device 602 with main receiver 604 and LP-WUR 606 in FIG. 6). At time T=0, only LP-WUR 706 is in an active mode (also referred to as an “powered on state” or “awake state”), while main receiver 704 is in an inactive mode (also referred to as a “powered off state” or “sleep state”).

LP-WUR 706 is configured to actively monitor for LP-WUSs while main receiver 704 is in the powered off state. In this example, LP-WUR 706 is configured to monitor for an LP-WUS according to a WUS monitoring periodicity. For example, the WUS monitoring periodicity may be defined as a plurality of symbols, a plurality of slots, a fixed time duration, etc. LP-WUR 706 may be configured to monitor for an LP-WUS in periodic LP-WUS monitoring occasions (e.g., such as LP-WUS monitoring occasion 740 and LP-WUS monitoring occasion 742). The LP-WUS monitoring periodicity may define the separation in time between start times of different LP-WUS monitoring occasions 740, 742.

In this example, an LP-WUS 712 is transmitted to wireless communications device 708 in LP-WUS monitoring occasion 742; thus, LP-WUR 706 receives LP-WUS 712 in LP-WUS monitoring occasion 742 when monitoring for LP-WUS 712.

LP-WUS 712 may be transmitted to wireless communications device 708 and received by LP-WUR 706, when a second SR message is intended to be sent in an upcoming uplink transmission resource, which may occur in a discontinuous reception (DRX) ON duration 750.

LP-WUS 712 received by LP-WUR 706 triggers wireless communications device 708 to wake up main receiver 704 to receive a transmission, such as in an upcoming DRX ON duration 750. After detecting LP-WUS 712, LP-WUR 706 transitions from the active mode to an inactive mode because when the main receiver 704 is on, LP-WUR 706 need not be monitoring for any LP-WUSs. Further, in response to the trigger from LP-WUR 706, main receiver 704 transitions from the inactive mode to an active mode to receive the second SR message 744.

### Example Signaling of a Two-step Scheduling Request

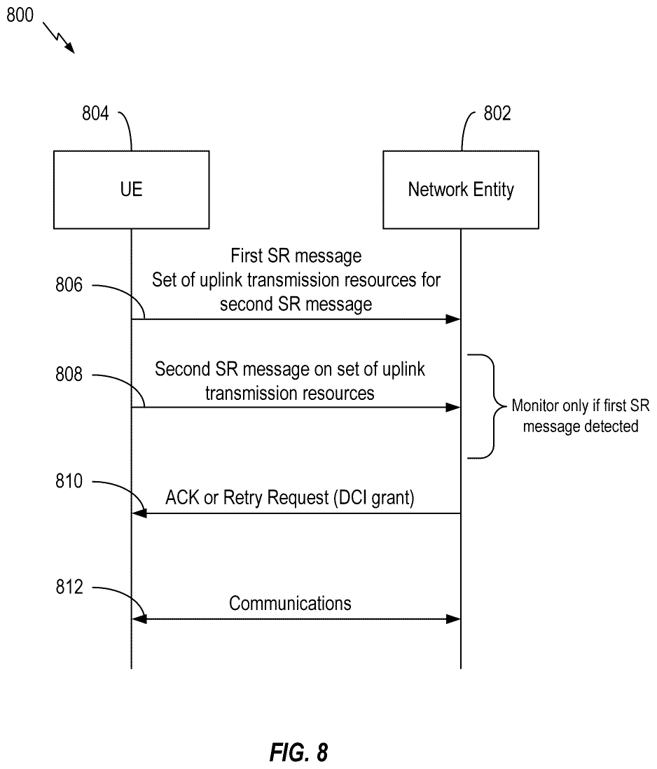

FIG. 8 depicts a process flow 800 for communications in a system between a network entity 802 and a UE 804. In some aspects, the network entity 802 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 804 may be an example of UE 104 depicted and described with respect to FIG. 1 or the UE 304 depicted and described with respect to FIG. 3. In certain cases, the UE 804 may be an example of the UE 504 of FIG. 5. However, in other aspects, UE 804 may be another type of wireless communications device, and network entity 802 may be another type of network entity or network node, such as those described herein. Note that any operations or signaling illustrated with dashed lines may indicate that that operation or signaling is an optional or alternative example.

At 806, the UE 804, having data to transmit to the network, transmits a first SR message to the network entity 802. The first SR message indicates that a specific set of uplink transmission resources is to be used for a second SR message, which alerts the network entity 802 to monitor the set of uplink transmission resources. In some aspects, the first SR message may be carried in the PUCCH, or alternatively in a PRACH preamble, as described below.

The specific set of uplink transmission resources may be preconfigured at the network entity 802. In some aspects, a separate signal, e.g., RRC signaling, may be used to configure the uplink transmission resources prior to process flow 800. The specific set of uplink transmission resources may be based on a standard configuration of uplink transmission resources for two-step SRs or may be based on UE capabilities signaling from UE 804 to network entity 802.

In some aspects, the first SR message may comprise an SR message flag. An SR message flag, such as a positive SR message flag, may include an indication that the message is a scheduling request. In some aspects, the first SR message may comprise a negative SR message flag indicating that the first SR message is not an SR. In some aspects, the first SR message may also include a triggering cause of an SR, such as an indication of a buffer status report (BSR), delay status report (DSR), bean failure report (BFR), or the like, which may allow the network entity 802 to prioritize the communication. In some other aspects, the first SR message may include an identifier for a logical channel that may be triggering the SR, where certain logical channels may have assigned priorities in the system relative to known quality of service (QoS) expectations. In some aspects, the first SR message may include an identifier for a triggering UE, e.g., UE 804, or UE group, where specific UEs or UE groups may also have assigned priorities in the system relative to the quality of service (QoS) expectations. In some aspects, the first SR message may include an indication of a time offset between the first and second SR messages, such that the network entity 802 may more efficiently monitor the set of uplink transmission resources. In some aspects, the first SR message may include one or more parameters of the set of uplink transmission resources, e.g., a specific offset, duration, time or frequency, that indicate specific resources that will be used. In this case, the one or more parameters are selected from the preconfigured set of uplink transmission resources described above. This may also allow the network entity 802 to efficiently monitor the set of uplink transmission resources according to the expectations of the network. It should be noted that in some aspects, at least some of information listed above may be part of the second SR message as described below (e.g., instead of the first SR message).

In some aspects, the network entity 802 may receive a first SR message from multiple UEs, and these first SR messages may be multiplexed into a common resource. In some aspects, the first SR messages may use a one-to-one mapping to the set of uplink transmission resources. This may be prone to high contention or collision, which may be sufficient in an environment with fewer UEs or infrequent traffic. In some aspects, the network entity 802 may configure multiple sets of uplink transmission resources that may be used for different UEs or UE groups. For example, a first SR message may have a one-to-many relationship with sets of uplink transmission resources, such that the first SR message can indicate any of multiple sets of uplink transmission resources. As another example, a first SR message may have a many-to-many relationship with sets of uplink transmission resources, such that any one of a plurality of first SR messages can indicate any one of a plurality of sets of uplink transmission resources.

In some aspects, the first and second SR messages may be sent via RACH signaling (either contention-based or contention-free), such as described in FIG. 5. In this case, the MSGA preamble may carry the first SR message and the MSGA payload may carry the second SR message, or MSG1 may carry the first SR message and MSG3 may carry the second SR message. In some aspects, the full RACH procedure may not be followed, such as by using only MSGA and not including any MSGB. The information in the first and second SR messages may be configured such that the information in the second SR message is more general. For example, the C-RNTI MAC CE and SR triggering information, e.g., BSR/DSR/BFR MAC CE, etc., may be used in the second SR message. In the case of multiplexing SR messages from multiple UEs as mentioned above, multiple different preamble indices may be used as an identifier for the specific UEs. In some aspects, different time and frequency resources may be configured for the different UEs in the RACH process. It should also be noted that using the RACH preamble to carry the first SR message may allow network entity 802 to measure channel conditions more accurately and ensure better reception of the second SR message and other data. The first SR message also allows low complexity receiver processing with its simplified design compared to the second SR message.

In some aspects, the first SR message may serve as or comprise a LP-WUS, as described with respect to FIGS. 6 and 7, where the network entity 802 may operate as the wireless communications device 708 of FIG. 7. In such a case, the first SR message may be based on an on-off keying (OOK) modulation. Also, the resulting energy expectations, e.g., Error Vector Magnitude (EVM) requirements, of both the UE 804 and network entity 802 may be different between the first and second SR messages. For instance, the EVM requirement may be relaxed to allow the first SR message to be sent more efficiently and able to be received by a low power receiver, e.g., LP-WUR 706. The time offset may be adjusted in this case to allow the network entity 802 to receive the LP-WUS and activate a main receiver, e.g., main receiver 704, to appropriately process the second SR message in the manner described below.

In some aspects, a first SR message may be configured by the UE 804 to indicate that the second SR message will not be transmitted. Such configuration may include modifying the cyclic shift of the first SR message. The decision by the UE 804 to not transmit the second SR message may be based on UE 804 only having a small amount of data to transmit. Such a decision may also be based on measured channel conditions, such as a path loss or Reference Signal Received Power (RSRP), or an information priority based on QoS of the traffic to be transmitted to the network entity 802.

At 808, the UE 804 transmits a second SR message to the network entity 802 using the set of uplink transmission resources. In some aspects, the second SR message may be carried in a control channel, e.g., PUCCH, or data channel, e.g., PUSCH. In some aspects, the second SR message may comprise some or all of the information described above with respect to the first SR message, e.g., the SR message flag, the triggering cause, an identifier for the logical channel, an identifier for the triggering UE or UE group, or one or more parameters of the set of the uplink transmission resources. The second SR message may also include one or more MAC CEs that indicate a reason for triggering the first SR message, e.g., the buffer status report, the delay status report, the beam failure recovery report, the beam report, or the like.

In some aspects, the information to be included in the second SR message may be set according to a prior configuration, e.g., RRC signaling or other methods. In some aspects, the prior configuration may specify a portion of the information to be included in the second SR message. In this case, the remaining information about the set of uplink transmission resources may be determined by making an optional request to the UE 804, or selected by requesting UE from a pre-configured list. Prioritization rules may also be defined for a UE to decide which information to be included in the second SR message in cases of limited payload for the second SR message. For example, the UE 804 may determine a set of information, to be included in the second SR message, based on an amount of available resources in the set of uplink transmission resources.

As mentioned above, in some aspects, the UE 804 may transmit an indication of an offset such as a time offset between the first SR message and the second SR message to the network entity 802. Alternatively, the time offset may be defined in a wireless communication specification. For example, in some aspects, the time offset between the first SR message and the second SR message may be a fixed value. Alternatively, the network entity 802 may configure the time offset. In some aspects, the time offset may follow a pattern that tracks the conditions of the scheduling process. One effect of a configurable time offset between the first and second SR messages may be a savings in energy and power consumption by the network entity 802. For example, if the first SR message indicates a negative SR message flag (meaning that the UE 804 has no data to transmit), a sufficiently large time offset (e.g., larger than potential delays created by processing of the first SR message and uplink scheduling delays) may allow the network entity 802 to repurpose the set of uplink transmission resources for other uses, such as for other UEs that may also send SR messages. In some aspects, the time offset is longer than a processing time associated with processing the first SR message, such that the network entity 802 can monitor the second set of uplink transmission resources only if the first SR message is detected, thereby saving energy.

In some aspects, the first SR message and the second SR message may be sent on separate frequencies or layers in a multiple frequency layer environment. For instance, the first SR message may be sent on an anchor frequency, e.g., a serving cell or a non-serving cell in a lower frequency, where the network entity may simply acknowledge the first SR message on the anchor frequency. This transmission may be followed by the second SR message being transmitted at a higher frequency (e.g., on a serving carrier). In some aspects, the serving carrier may be in a network energy saving state, and the first SR message may trigger the network entity 802 to activate the serving carrier to receive the second SR message. In this case, the time offset may be sufficiently long to accommodate a time associated with waking up the serving carrier. Transmission on distinct frequencies may have the technical effect of reducing resource overhead on a busy anchor frequency.

In some aspects, separate MIMO schemes may be used to send the first and second SR messages. For instance, the first SR message may be sent using a first MIMO scheme having a higher antenna diversity (e.g., a larger number of antennas) to increase robustness, while the second SR message may be sent with a MIMO scheme such as open-loop MIMO. In such a case, the first SR message may be used as a reference signal for channel estimation of the set of uplink transmission resources, where both the first and second SR messages are sent on the same antenna port and the network entity 802 is configured to use the first SR message for the channel estimation.

In some aspects, the first SR message may be used as a pilot for estimating channel conditions while using the set of uplink transmission resources. By using the first SR message as a pilot for measuring the channel conditions, the DMRS signal may be reduced or eliminated with respect to the second SR message by the UE 804. For example, the second SR message may include a reduced number of DMRS pilots relative to a baseline PUSCH configuration. As another example, the second SR message may include no DMRS pilots. In another example, the second SR message may also comprise a sounding reference signal (SRS).

At 810, the network entity 802 transmits a downlink message to the UE 804. The downlink message transmitted by the network entity 802 may comprise a first downlink message indicating that the second SR message has been received, e.g., in the event that the second SR message is received by the network entity 802. Alternatively, the downlink message may comprise a second downlink message indicating that the second SR message has not been received, e.g., in the event that the network entity 802 fails to decode the second SR message, or a second SR message is not received at the appropriate time. A first downlink message may comprise an acknowledgment (ACK) or downlink confirmation of receipt to the UE 804. A second downlink message may comprise a retry request, which may include a DCI grant for uplink transmission resources on which to retransmit the second SR message. In the case of a second downlink message, the UE 804 may retransmit the second SR message, allowing the network entity 802 to combine the retransmission of the second SR message with an initial reception of the second SR message in the event that partial information of the second SR message was received in the initial reception. In some aspects, the UE 804 may modify the second SR message to include different information in the retransmitted message as needed. The process may be repeated as necessary to complete the transmission of the second SR message, where the UE 804 may retry up to a maximum count if no acknowledgment is received from the network entity 802 within a time window. In some aspects, the downlink message, may be carried by PDCCH DCI, MAC CE, or in RRC signaling.

At 812, one the scheduling process is complete, uplink communication between the UE 804 and network entity 802 begins, where the UE 804 transmits data over the PUSCH in accordance with a scheduled resource. For example, the network entity 802 may transmit DCI to the UE 804, in response to the first SR message and/or the second SR message, indicating a scheduled resource. The UE 804 may transmit, and the network entity 802 may receive, a message on the scheduled resource.

Note that the process flow illustrated in FIG. 8 is described herein to facilitate an understanding of channel aware SPS configuration, and aspects of the present disclosure may be performed in various manners via alternative or additional signaling and/or operations. In certain aspects, the operations and/or signaling of FIG. 8 may occur in an order different from that described or depicted, and various actions, operations, and/or signaling may be added, omitted, or combined.

### Example Operations of a User Equipment

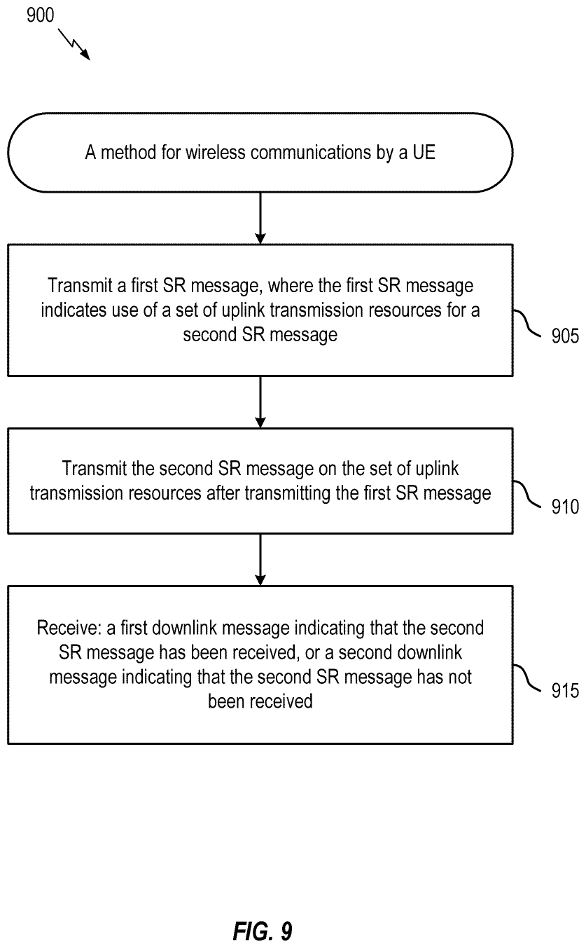

FIG. 9 shows a method 900 for wireless communications by a user equipment, such as UE 104 of FIG. 1 or UE 304 of FIG. 3.

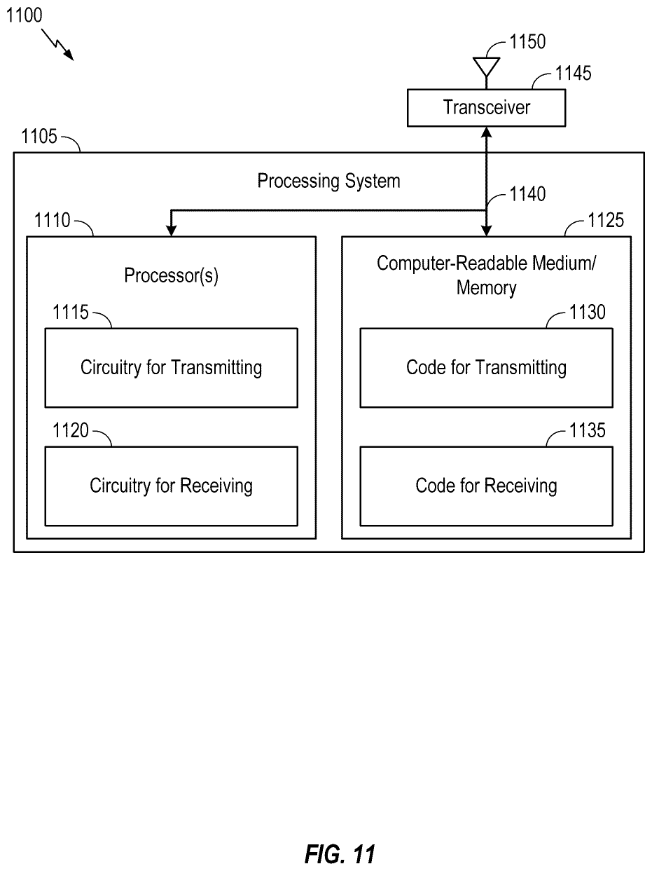

Method 900 begins at block 905 with transmitting a first SR message, where the first SR message indicates use of a set of uplink transmission resources for a second SR message. For example, UE 804 may transmit a first SR message indicating use of a set of uplink transmission resources for a second SR message by network entity 802, as depicted and described above with respect to reference 806 of FIG. 8. The block 905 may also be implemented by a processor or memory or by an example communications device as described in FIG. 11.

Method 900 then proceeds to block 910 with transmitting the second SR message on the set of uplink transmission resources after transmitting the first SR message. For example, UE 804 may transmit a second SR message on the set of uplink transmission resources after transmitting the first SR message to network entity 802, as depicted and described above with respect to reference 808 of FIG. 8. The block 910 may also be implemented by a processor or memory or by an example communications device as described in FIG. 11.

Method 900 then proceeds to block 915 with receiving: a first downlink message indicating that the second SR message has been received, or a second downlink message indicating that the second SR message has not been received. For example, UE 804 may receive a first downlink message indicating that the second SR message has been received, or a second downlink message indicating that the second SR message has not been received from network entity 802, as depicted and described above with respect to reference 810 of FIG. 8. The block 915 may also be implemented by a processor or memory or by an example communications device as described in FIG. 11.

In some aspects, the first SR message includes first information comprising one or more of: an SR message flag indicating a presence of the second SR message, a triggering cause of the first SR message, a first identifier of a logical channel triggering the first SR message, a second identifier of a triggering UE or UE group, an offset between the first and second SR messages, or a parameter of the set of the uplink transmission resources.

In some aspects, the second SR message includes second information comprising one or more of: a triggering cause of the first SR message, a first identifier of a logical channel triggering the first SR message, a second identifier of a triggering UE or UE group, or one or more MAC CEs that trigger the first SR message, where the one or more MAC CEs belong to the logical channel triggering the first SR message.

In some aspects, the second information is based on an amount of available resources of the set of uplink transmission resources and an information priority.

In some aspects, block 910 includes transmitting the second SR message according to a configured time offset from the first SR message.

In some aspects, the first SR message comprises one or more of: a PUCCH message, a PRACH preamble, and a LP-WUS.

In some aspects, the second SR message comprises one or more of: a PUCCH SR message, a PUSCH message, and an SRS.

In some aspects, block 905 includes transmitting the first SR message at a first frequency, and where block 910 includes transmitting the second SR message at a second frequency different from the first frequency.

In some aspects, block 905 includes transmitting the first SR message on a first antenna port and, where block 910 includes transmitting the second SR message on a second antenna port different from the first antenna port.

In some aspects, block 905 includes transmitting the first SR message at a first power level and, where block 910 includes transmitting the second SR message at a second power level different from the first power level.

In some aspects, block 905 includes transmitting the first SR message using a first MIMO scheme for transmission and block 910 includes transmitting the second SR message using a second MIMO scheme for transmission.

In some aspects, method 900, or any aspect related to it, may be performed by an apparatus, such as communications device 1100 of FIG. 11, which includes various components operable, configured, or adapted to perform the method 900. Communications device 1100 is described below in further detail.

Note that FIG. 9 is just one example of a method, and other methods including fewer, additional, or alternative operations are possible consistent with this disclosure.

### Example Operations of a Network Entity

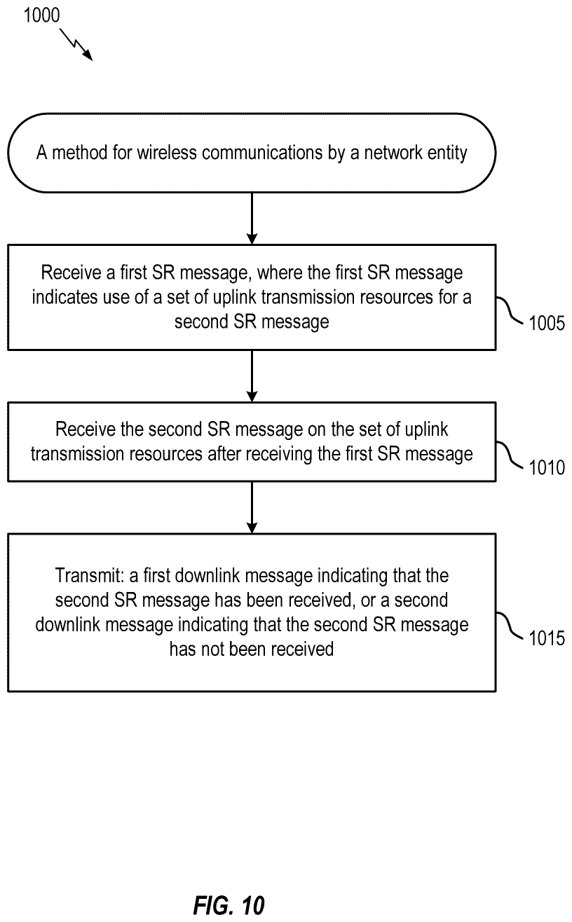

FIG. 10 shows a method 1000 for wireless communications by a network entity, such as BS 102 of FIG. 1, a first network entity 300 or second network entity 302 of FIG. 3, or a disaggregated base station as discussed with respect to FIG. 2.

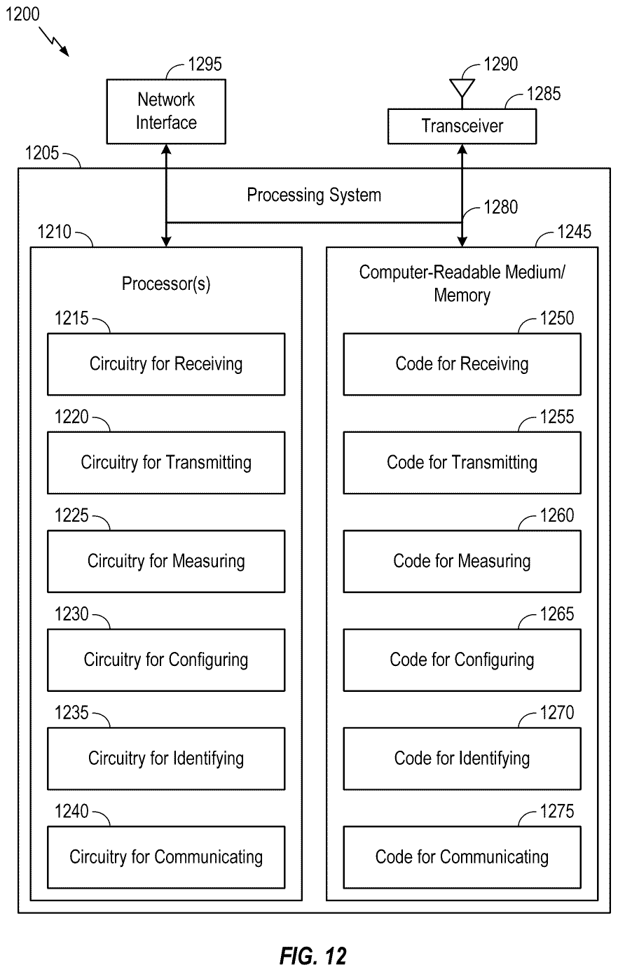

Method 1000 begins at block 1005 with receiving a first SR message, where the first SR message indicates use of a set of uplink transmission resources for a second SR message. For example, network entity 802 may receive, from UE 804, a first SR message indicating use of a set of uplink transmission resources for a second SR message, as depicted and described above with respect to reference 806 of FIG. 8. The block 1005 may also be implemented by a processor or memory or by an example communications device as described in FIG. 12.

Method 1000 then proceeds to block 1010 with receiving the second SR message on the set of uplink transmission resources after receiving the first SR message. For example, network entity 802 may receive, from UE 804, a second SR message on the set of uplink transmission resources after receiving the first SR message from UE 804, as depicted and described above with respect to reference 808 of FIG. 8. The block 1010 may also be implemented by a processor or memory or by an example communications device as described in FIG. 12.

Method 1000 then proceeds to block 1015 with transmitting: a first downlink message indicating that the second SR message has been received, or a second downlink message indicating that the second SR message has not been received. For example, network entity 802 may transmit a first downlink message indicating that the second SR message has been received, or a second downlink message indicating that the second SR message has not been received to UE 804, as depicted and described above with respect to reference 810 of FIG. 8. The block 1015 may also be implemented by a processor or memory or by an example communications device as described in FIG. 12.

In some aspects, the first SR message includes first information comprising one or more of: an SR message flag indicating a presence of the second SR message, a triggering cause of the first SR message, a first identifier of a logical channel triggering the first SR message, a second identifier of a triggering UE or UE group, an offset between the first and second SR messages, or a parameter of the set of uplink transmission resources.

In some aspects, the second SR message includes second information comprising one or more of: a triggering cause of the first SR message, a first identifier of a logical channel triggering the first SR message, a second identifier of a triggering UE or UE group, or one or more MAC CEs that trigger the first SR message, where the one or more MAC CEs belong to the logical channel triggering the first SR message.

In some aspects, block 1005 includes receiving the first SR message using a LP-WUR and, where block 1010 includes receiving the second SR message using a main receiver.

In certain aspects, method 1000 further includes measuring channel conditions based on the first SR message.

In certain aspects, method 1000 further includes receiving the second SR message based on the channel conditions.

In certain aspects, method 1000 further includes configuring, for a plurality of UEs, a plurality of sets of uplink transmission resources including the set of uplink transmission resources.

In some aspects, the first SR message is associated with the plurality of UEs and where block 1010 includes: identifying, based on the first SR message, an associated set of uplink transmission resources for a UE in the plurality of UEs; and communicating with the UE in the plurality of UEs according to the associated set of uplink transmission resources.

In some aspects, identifying the associated set of uplink transmission resources comprises identifying the associated set of uplink transmission resources based on a UE identifier.

In some aspects, method 1000, or any aspect related to it, may be performed by an apparatus, such as communications device 1200 of FIG. 12, which includes various components operable, configured, or adapted to perform the method 1000. Communications device 1200 is described below in further detail.

Note that FIG. 10 is just one example of a method, and other methods including fewer, additional, or alternative operations are possible consistent with this disclosure.

### Example Communications Devices

FIG. 11 depicts aspects of an example communications device 1100 configured for wireless communications. In some aspects, communications device 1100 is a user equipment, such as UE 104 described above with respect to FIG. 1 or UE 304 described with respect to FIG. 3.

The communications device 1100 includes a processing system 1105 coupled to a transceiver 1145 (e.g., a transmitter and/or a receiver). The transceiver 1145 is configured to transmit and receive signals for the communications device 1100 via an antenna 1150, such as the various signals as described herein. The processing system 1105 may be configured to perform processing functions for the communications device 1100, including processing signals received and/or to be transmitted by the communications device 1100.

The processing system 1105 includes one or more processors 1110 and a computer-readable medium/memory 1125. In various aspects, the one or more processors 1110 may be representative of the one or more processors 318 described with respect to FIG. 3. The one or more processors 1110 are coupled to a computer-readable medium/memory 1125 via a bus 1140. In some aspects, the computer-readable medium/memory 1125 may be representative of the one or more memories 320 described with respect to FIG. 3. The computer-readable medium/memory 1125 is a non-transitory computer-readable medium/memory. In certain aspects, the computer-readable medium/memory 1125 is configured to store instructions (e.g., computer-executable code), that when executed by the one or more processors 1110, cause the one or more processors 1110 to perform the method 900 described with respect to FIG. 9, or any aspect related to it, including any operations described in relation to FIG. 9. Note that reference to a processor performing a function of communications device 1100 may include one or more processors performing that function of communications device 1100, such as in a distributed fashion.

In the depicted example, computer-readable medium/memory 1125 stores code (e.g., executable instructions), including code for transmitting 1130 and code for receiving 1135. Processing of the code 1130 and 1135 may enable and cause the communications device 1100 to perform the method 900 described with respect to FIG. 9, or any aspect related to it. For instance, in some aspects, code for transmitting 1130 includes code for transmitting a first SR message, wherein the first SR message indicates use of a set of uplink transmission resources for a second SR message. In some aspects, code for transmitting 1130 includes code for transmitting the second SR message on the set of uplink transmission resources after transmitting the first SR message. In some aspects, code for receiving 1135 includes code for receiving: a first downlink message indicating that the second SR message has been received, or a second downlink message indicating that the second SR message has not been received.

The one or more processors 1110 include circuitry configured to implement (e.g., execute) the code stored in the computer-readable medium/memory 1125, including circuitry for transmitting 1115 and circuitry for receiving 1120. Processing with circuitry 1115 and 1120 may enable and cause the communications device 1100 to perform the method 900 described with respect to FIG. 9, or any aspect related to it. For instance, in some aspects, circuitry for transmitting 1115 includes circuitry for transmitting a first SR message, wherein the first SR message indicates use of a set of uplink transmission resources for a second SR message. In some aspects, circuitry for transmitting 1115 includes circuitry for transmitting the second SR message on the set of uplink transmission resources after transmitting the first SR message. In some aspects, circuitry for receiving 1120 includes circuitry for receiving: a first downlink message indicating that the second SR message has been received, or a second downlink message indicating that the second SR message has not been received.

More generally, means for communicating, transmitting, sending or outputting for transmission may include the one or more transceivers 324, one or more antenna 322 and/or processing system 316 of the UE 304 illustrated in FIG. 3, transceiver 1145 and/or antenna 1150 of the communications device 1100 in FIG. 11, and/or one or more processors 1110 of the communications device 1100 in FIG. 11. Means for communicating, receiving or obtaining may include the one or more transceivers 324, one or more antennas 322, and/or processing system 316 of the UE 304 illustrated in FIG. 3, transceiver 1145 and/or antenna 1150 of the communications device 1100 in FIG. 11, and/or one or more processors 1110 of the communications device 1100 in FIG. 11.

FIG. 12 depicts aspects of an example communications device configured for wireless communications. In some aspects, communications device 1200 is a network entity, such as BS 102 of FIG. 1, first network entity 300 or second network entity 302 of FIG. 3, or a disaggregated base station as discussed with respect to FIG. 2.

The communications device 1200 includes a processing system 1205 coupled to a transceiver 1285 (e.g., a transmitter and/or a receiver) and/or a network interface 1295. The transceiver 1285 is configured to transmit and receive signals for the communications device 1200 via an antenna 1290, such as the various signals as described herein. The network interface 1295 is configured to obtain and send signals for the communications device 1200 via communications link(s), such as a backhaul link, midhaul link, and/or fronthaul link as described herein, such as with respect to FIG. 2. The processing system 1205 may be configured to perform processing functions for the communications device 1200, including processing signals received and/or to be transmitted by the communications device 1200.

The processing system 1205 includes one or more processors 1210 and a computer-readable medium/memory 1245. In various aspects, one or more processors 1210 may be representative of the one or more processors 308, as described with respect to FIG. 3. The one or more processors 1210 are coupled to the computer-readable medium/memory 1245 via a bus 1280. In certain aspects, the computer-readable medium/memory 1245 is configured to store instructions (e.g., computer-executable code), including code 1250-1275, that when executed by the one or more processors 1210, cause the one or more processors 1210 to perform the method 1000 described with respect to FIG. 10, or any aspect related to it, including any operations described in relation to FIG. 10. The computer-readable medium/memory 1245 is a non-transitory computer-readable medium/memory. Note that reference to a processor of communications device 1200 performing a function may include one or more processors of communications device 1200 performing that function, such as in a distributed fashion.

In the depicted example, the computer-readable medium/memory 1245 stores code (e.g., executable instructions), including code for receiving 1250, code for transmitting 1255, code for measuring 1260, code for configuring 1265, code for identifying 1270, and code for communicating 1275. Processing of the code 1250-1275 may enable and cause the communications device 1200 to perform the method 1000 described with respect to FIG. 10, or any aspect related to it. For instance, in some aspects, code for receiving 1250 includes code for receiving a first SR message, wherein the first SR message indicates use of a set of uplink transmission resources for a second SR message. In some aspects, code for receiving 1250 includes code for receiving the second SR message on the set of uplink transmission resources after receiving the first SR message. In some aspects, code for transmitting 1255 includes code for transmitting: a first downlink message indicating that the second SR message has been received, or a second downlink message indicating that the second SR message has not been received.

The one or more processors 1210 include circuitry configured to implement (e.g., execute) the code stored in the computer-readable medium/memory 1245, including circuitry for receiving 1215, circuitry for transmitting 1220, circuitry for measuring 1225, circuitry for configuring 1230, circuitry for identifying 1235, and circuitry for communicating 1240. Processing with circuitry 1215-1240 may enable and cause the communications device 1200 to perform the method 1000 described with respect to FIG. 10, or any aspect related to it. For instance, in some aspects, circuitry for receiving 1215 includes circuitry for receiving a first SR message, wherein the first SR message indicates use of a set of uplink transmission resources. In some aspects, circuitry for receiving 1215 includes circuitry for receiving a second SR message on the set of uplink transmission resources. In some aspects, circuitry for transmitting 1220 includes circuitry for transmitting: a first downlink message indicating that the second SR message has been received, or a second downlink message indicating that the second SR message has not been received.

Various components of the communications device 1200 may provide means for performing the method 1000 described with respect to FIG. 10, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1285, antenna 1290, and/or network interface 1295 of the communications device 1200 in FIG. 12, and/or one or more processors 1210 of the communications device 1200 in FIG. 12. Means for communicating, receiving or obtaining may include the one or more transceivers 312, one or more antennas 314, and/or processing system 306 of the first network entity 300 or the second network entity 302 illustrated in FIG. 3, transceiver 1285, antenna 1290, and/or network interface 1295 of the communications device 1200 in FIG. 12, and/or one or more processors 1210 of the communications device 1200 in FIG. 12.

### Example Clauses

Implementation examples are described in the following numbered clauses:

Clause 1: A method for wireless communications by a UE comprising: transmitting a first SR message, wherein the first SR message indicates use of a set of uplink transmission resources for a second SR message; transmitting the second SR message on the set of uplink transmission resources after transmitting the first SR message; and receiving: a first downlink message indicating that the second SR message has been received, or a second downlink message indicating that the second SR message has not been received.

Clause 2: The method of Clause 1, wherein the first SR message includes first information comprising one or more of: an SR message flag indicating a presence of the second SR message, a triggering cause of the first SR message, a first identifier of a logical channel triggering the first SR message, a second identifier of a triggering UE or UE group, an offset between the first and second SR messages, or a parameter of the set of the uplink transmission resources.

Clause 3: The method of any one of Clauses 1-2, wherein the second SR message includes second information comprising one or more of: a triggering cause of the first SR message, a first identifier of a logical channel triggering the first SR message, a second identifier of a triggering UE or UE group, or one or more MAC CEs that trigger the first SR message, wherein the one or more MAC CEs belong to the logical channel triggering the first SR message.

Clause 4: The method of Clause 3, wherein the second information is based on an amount of available resources of the set of uplink transmission resources and an information priority.

Clause 5: The method of any one of Clauses 1-4, wherein transmitting the second SR message on the set of uplink transmission resources comprises transmitting the second SR message according to a configured time offset from the first SR message.

Clause 6: The method of any one of Clauses 1-5, wherein the first SR message comprises one or more of: a PUCCH message, a PRACH preamble, and a LP-WUS.

Clause 7: The method of any one of Clauses 1-6, wherein the second SR message comprises one or more of: a PUCCH SR message, a PUSCH message, and an SRS.

Clause 8: The method of any one of Clauses 1-7, wherein transmitting the first SR message comprises transmitting the first SR message at a first frequency, and wherein transmitting the second SR message comprises transmitting the second SR message at a second frequency different from the first frequency.

Clause 9: The method of any one of Clauses 1-8, wherein transmitting the first SR message comprises transmitting the first SR message on a first antenna port and, wherein transmitting the second SR message comprises transmitting the second SR message on a second antenna port different from the first antenna port.

Clause 10: The method of any one of Clauses 1-9, wherein transmitting the first SR message comprises transmitting the first SR message at a first power level and, wherein transmitting the second SR message comprises transmitting the second SR message at a second power level different from the first power level.

Clause 11: The method of any one of Clauses 1-10, wherein transmitting the first SR message comprises transmitting the first SR message using a first MIMO scheme for transmission and, wherein transmitting the second SR message comprises transmitting the second SR message using a second MIMO scheme for transmission.

Clause 12: A method for wireless communications by a network entity comprising: receiving a first SR message, wherein the first SR message indicates use of a set of uplink transmission resources for a second SR message; receiving the second SR message on the set of uplink transmission resources after receiving the first SR message; and transmitting: a first downlink message indicating that the second SR message has been received, or a second downlink message indicating that the second SR message has not been received.

Clause 13: The method of Clause 12, wherein the first SR message includes first information comprising one or more of: an SR message flag indicating a presence of the second SR message, a triggering cause of the first SR message, a first identifier of a logical channel triggering the first SR message, a second identifier of a triggering UE or UE group, an offset between the first and second SR messages, or a parameter of the set of uplink transmission resources.

Clause 14: The method of any one of Clauses 12-13, wherein the second SR message includes second information comprising one or more of: a triggering cause of the first SR message, a first identifier of a logical channel triggering the first SR message, a second identifier of a triggering UE or UE group, or one or more MAC CEs that trigger the first SR message, wherein the one or more MAC CEs belong to the logical channel triggering the first SR message.

Clause 15: The method of any one of Clauses 12-14, wherein receiving the first SR message comprises receiving the first SR message using a LP-WUR and, wherein receiving the second SR message comprises receiving the second SR message using a main receiver.

Clause 16: The method of any one of Clauses 12-15, further comprising: measuring channel conditions based on the first SR message; and receiving the second SR message based on the channel conditions.

Clause 17: The method of any one of Clauses 12-16, further comprising: configuring, for a plurality of UEs, a plurality of sets of uplink transmission resources including the set of uplink transmission resources.

Clause 18: The method of Clause 17, wherein the first SR message is associated with the plurality of UEs and wherein receiving the second SR message comprises: identifying, based on the first SR message, an associated set of uplink transmission resources for a UE in the plurality of UEs; and communicating with the UE in the plurality of UEs according to the associated set of uplink transmission resources.

Clause 19: The method of Clause 18, wherein identifying the associated set of uplink transmission resources comprises identifying the associated set of uplink transmission resources based on a UE identifier.

Clause 20: One or more apparatuses, comprising: one or more memories comprising executable instructions; and one or more processors configured to execute the executable instructions and cause the one or more apparatuses to perform a method in accordance with any one of Clauses 1-19.

Clause 21: One or more apparatuses configured for wireless communications, comprising: one or more memories; and one or more processors, coupled to the one or more memories, configured to cause the one or more apparatuses to perform a method in accordance with any one of Clauses 1-19.

Clause 22: One or more apparatuses configured for wireless communications, comprising: one or more memories; and one or more processors, coupled to the one or more memories, configured to perform a method in accordance with any one of Clauses 1-20.

Clause 23: One or more apparatuses, comprising means for performing a method in accordance with any one of Clauses 1-19.

Clause 24: One or more non-transitory computer-readable media comprising executable instructions that, when executed by one or more processors of one or more apparatuses, cause the one or more apparatuses to perform a method in accordance with any one of Clauses 1-19.

Clause 25: One or more computer program products embodied on one or more computer-readable storage media comprising code for performing a method in accordance with any one of Clauses 1-19.

Clause 27: One or more apparatuses configured for wireless communications, comprising: a processing system that includes one or more processors and one or more memories coupled with the one or more processors, the processing system configured to cause the one or more apparatuses to perform a method in accordance with any one of Clauses 1-19.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus for wireless communications, comprising a processing system that includes one or more processors and one or more memories coupled with the one or more processors, the processing system configured to cause a user equipment (UE) to:
transmit a first scheduling request (SR) message, wherein the first SR message indicates use of a set of uplink transmission resources for a second SR message;
transmit the second SR message on the set of uplink transmission resources after transmitting the first SR message; and
receive:
a first downlink message indicating that the second SR message has been received, or
a second downlink message indicating that the second SR message has not been received.

2. The apparatus of claim 1, wherein the first SR message includes first information comprising one or more of:
an SR message flag indicating a presence of the second SR message,
a triggering cause of the first SR message,
a first identifier of a logical channel triggering the first SR message,
a second identifier of a triggering UE or UE group,
an offset between the first and second SR messages, or
a parameter of the set of the uplink transmission resources.

3. The apparatus of claim 1, wherein the second SR message includes second information comprising one or more of:
a triggering cause of the first SR message,
a first identifier of a logical channel triggering the first SR message,
a second identifier of a triggering UE or UE group, or
one or more MAC CEs that trigger the first SR message, wherein the one or more MAC CEs belong to the logical channel triggering the first SR message.

4. The apparatus of claim 3, wherein the second information is based on an amount of available resources of the set of uplink transmission resources and an information priority.

5. The apparatus of claim 1, wherein to cause the UE to transmit the second SR message on the set of uplink transmission resources, the processing system is configured to cause the UE to transmit the second SR message according to a configured time offset from the first SR message.

6. The apparatus of claim 1, wherein the first SR message comprises one or more of: a physical uplink control channel (PUCCH) message, a physical random access channel (PRACH) preamble, or a low-power wake-up signal (LP-WUS).

7. The apparatus of claim 1, wherein the second SR message comprises one or more of: a physical uplink control channel (PUCCH) SR message, a physical uplink shared channel (PUSCH) message, or a Sounding Reference Signal (SRS).

8. The apparatus of claim 1, wherein to cause the UE to transmit the first SR message, the processing system is configured to cause the UE to transmit the first SR message at a first frequency, and wherein to cause the UE to transmit the second SR message, the processing system is configured to cause the UE to transmit the second SR message at a second frequency different from the first frequency.

9. The apparatus of claim 1, wherein to cause the UE to transmit the first SR message, the processing system is configured to cause the UE to transmit the first SR message on a first antenna port and, wherein to cause the UE to transmit the second SR message, the processing system is configured to cause the UE to transmit the second SR message on a second antenna port different from the first antenna port.

10. The apparatus of claim 1, wherein to cause the UE to transmit the first SR message, the processing system is configured to cause the UE to transmit the first SR message at a first power level and, wherein to cause the UE to transmit the second SR message, the processing system is configured to cause the UE to transmit the second SR message at a second power level different from the first power level.

11. The apparatus of claim 1, wherein to cause the UE to transmit the first SR message, the processing system is configured to cause the UE to transmit the first SR message using a first multiple-input and multiple-output (MIMO) scheme for transmission and wherein to cause the UE to transmit the second SR message, the processing system is configured to cause the UE to transmit the second SR message using a second MIMO scheme for transmission.

12. An apparatus for wireless communications, comprising a processing system that includes one or more processors and one or more memories coupled with the one or more processors, the processing system configured to cause a network entity to:
receive a first scheduling request (SR) message, wherein the first SR message indicates use of a set of uplink transmission resources for a second SR message;
receive the second SR message on the set of uplink transmission resources after receiving the first SR message; and
transmit:
a first downlink message indicating that the second SR message has been received, or
a second downlink message indicating that the second SR message has not been received.

13. The apparatus of claim 12, wherein the first SR message includes first information comprising one or more of:
an SR message flag indicating a presence of the second SR message,
a triggering cause of the first SR message,
a first identifier of a logical channel triggering the first SR message,
a second identifier of a triggering UE or UE group,
an offset between the first and second SR messages, or
a parameter of the set of uplink transmission resources.

14. The apparatus of claim 12, wherein the second SR message includes second information comprising one or more of:
a triggering cause of the first SR message,
a first identifier of a logical channel triggering the first SR message,
a second identifier of a triggering UE or UE group, or
one or more MAC CEs that trigger the first SR message, wherein the one or more MAC CEs belong to the logical channel triggering the first SR message.

15. The apparatus of claim 12, wherein to cause the network entity to receive the first SR message, the processing system is configured to cause the network entity to receive the first SR message using a low-power wake-up receiver (LP-WUR) and, wherein to cause the network entity to receive the second SR message, the processing system is configured to cause the network entity to receive the second SR message using a main receiver.

16. The apparatus of claim 12, wherein the processing system is configured to cause the network entity to:
measure channel conditions based on the first SR message; and
receive the second SR message based on the channel conditions.

17. The apparatus of claim 12, wherein the processing system is configured to cause the network entity to:
configure, for a plurality of user equipments (UEs), a plurality of sets of uplink transmission resources including the set of uplink transmission resources.

18. The apparatus of claim 17, wherein the first SR message is associated with the plurality of UEs and wherein to cause the network entity to receive the second SR message, the processing system is configured to cause the network entity to:
identify, based on the first SR message, an associated set of uplink transmission resources for a UE in the plurality of UEs; and
communicate with the UE in the plurality of UEs according to the associated set of uplink transmission resources.

19. The apparatus of claim 18, wherein to cause the network entity to identify the associated set of uplink transmission resources, the processing system is configured to cause the network entity to identify the associated set of uplink transmission resources based on a UE identifier.

20. A method of wireless communications, comprising:
transmitting a first scheduling request (SR) message, wherein the first SR message indicates use of a set of uplink transmission resources for a second SR message;
transmitting the second SR message on the set of uplink transmission resources after transmitting the first SR message; and
receiving:
a first downlink message indicating that the second SR message has been received, or
a second downlink message indicating that the second SR message has not been received.
